(19) United States
(12) Patent Application Publication
(10) Pub. No.: US 2017/0048308 A1
(43) Pub. Date: Feb. 16, 2017

(54) System and Apparatus for Network Conscious Edge to Cloud Sensing, Analytics, Actuation and Virtualization

(71) Applicant: Saad Bin Qaisar, Islamabad (PK)

(72) Inventor: Saad Bin Qaisar, Islamabad (PK)

(21) Appl. No.: 15/236,458

(22) Filed: Aug. 14, 2016

Related U.S. Application Data
(60) Provisional application No. 62/204,459, filed on Aug. 13, 2015.

(51) Int. Cl. H04L 29/08; H04L 12/24; H04L 12/927

(52) U.S. Cl. CPC H04L 67/1002; H04L 47/803; H04L 41/0806; H04L 41/145; H04L 67/12

(57) ABSTRACT

The invention is method and apparatus for network conscious edge-to-cloud data aggregation, connectivity, analytics and actuation operate for the detection and actuation of events based on sensed data, with the assistance of edge computing software-defined fog engine with interconnect with other network elements via programmable internet exchange points to ensure end-to-end virtualization with cloud data centers and hence, resource reservations for guaranteed quality of service in event detection.

### CROSS REFERENCE TO RELATED APPLICATION

The present application is related to Provisional patent application entitled “System and Method for Network Conscious Edge to Cloud Sensing, Communication, Analytics, Actuation and Virtualization,” filed 13 Aug. 2015 and assigned filing No. 62/204,459, incorporated herein by reference in its entirety.

### FIELD OF THE INVENTION

The subject matter disclosed herein relates to a system and/or method for introducing end to end virtualization for sensing devices, network edge computation machines/infrastructure and cloud servers from physical sensing devices to the cloud data centres via intermediate edge computation machines connected to a network controller(s), programmable data plane and programmable internet exchange points ensuring end to end data plane programmability for applications such as monitoring the environmental conditions/images/parameters, stability and movement and/or position of personnel in a sample target environment via a single or network of sensing devices. Further, this invention deploys machine learning and/or statistical and/or artificial intelligence techniques to determine and/or predict and/or detect and/or identify and localize the key events and trigger actuators for timely action with a provision for guaranteed end to end computing and network resources from network edge to cloud data centers via the programmable data plane through the use of software defined network controllers and programmable internet exchange points.

### BACKGROUND OF THE INVENTION

Many systems have been used in the past for sensing, communication, analytics and actuation. Most of these systems involve a wired and/or a wireless sensor network to collect either the environmental data and/or information about the personnel working in the sample target environment and communicate the collected data and/or information back to the central node. The sensor network, in these systems consist of sensor nodes, each mounted with various sensors to monitor one or more of the temperature, pressure, humidity, seismic activity, toxic gases, water ingress, light concentration and a transmitter to broadcast the collected information to a powerful sink node which may have higher processing capabilities. Further, the central node may deploy a machine learning and/or statistical and/or artificial intelligence based technique to detect and/or predict a disaster event.

Some solutions, in addition to collecting/gathering information from various spatial locations of the deployment, also claim an ability to determine the location of the personnel working inside the sample target environment after an event has been detected. These systems have inherent cost limitations as they require the collected information/data related to environment and personnel to be transmitted to a central node. Continuous communication of data on a large scale may also limit the battery life of such centralized systems. Furthermore, in the state-of-the-art systems, the sensor nodes on personnel do not participate in the detection/prediction of event.

In comparison, a distributed system may overcome the issues associated with a centralized system. A distributed system may involve a set of wireless sensors spatially distributed along the sample target environment, as well as a few wireless sensors installed on the personnel working inside the environment. In contrast to the centralized system, where each sensor has the ability to sense one or more of the environmental parameters and communicate them to a centralized location, the sensor nodes in a distributed system are equipped with some processing capabilities. These sensor nodes process the data to extract some useful information and then communicate only the sufficient statistics to the centralized location.

Certain example embodiments of this invention also disclose that the sensor nodes may be installed on the personnel—the mobile sensors. These mobile nodes, in a distributed system, are also equipped with processing capabilities and can assist the static nodes in detecting an event/collapse. Certain example embodiments of this invention may also claim that one or more static and/or mobile sensor nodes may be in a sleep/inactive mode in normal working conditions inside the sample target environment. This mode of operation makes the claimed system described below operable for longer time periods and hence cost effective as compared to the existing state-of-the-art systems.

Client sensor devices are typically equipped with ample resources of storage, communication and computation. Leveraging these devices to descend the concept of cloud close to the users has been given the name of fog networking. Fog networking is a technology operating to use resources already present at the cloud edge to provide a network that can support low latency, geographically distributed, and mobile applications of Internet of Things (IoT) and Wireless Sensor Networks (WSNs).

Software-defined networking is a technology operating to provide programmable and flexible networks by separating the control plane from the data plane. These two technologies are combined to create a powerful and programmable network architecture to support increasing applications of IoT networks. The present invention pertains to the concept of fog networks steered by programmable internet exchange points for application specific peering and content distribution, principles that form the basis for fog networks, and integration of data plane programmability and control via software defined networking (SDN) in such a system right from the device to network edge to the cloud data centres. Such architecture ensures: a.) support for massive scalability and massive connectivity; b.) flexible and efficient use of available resources (bandwidth and power); and c.) supporting diverse set of applications having different requirements using a single architecture.

Conventional cloud computing architectures alone are not sufficient to meet these requirements, and cannot handle the massive data produced by all future internet of things. Today's cloud models are not feasible for the variety, volume and velocity of data that IoT generates. In way of example, key requirements of such IoT systems which cloud cannot handle include:
Minimum Latency. Next generation computing devices and networks such as autonomous vehicles require low latency communication between themselves and with infrastructure such as roadside units. Similarly industrial automation requires low latency communication between various sensing nodes and between nodes and actuators. Cloud models are not capable of providing such low latency communications. For next generation networks to work, latency should be less than one millisecond to provide highly mobile communication links.
High reliability. Industrial automation and smart traffic systems require highly available and highly reliable networks to provide 24/7 monitoring service.
Power constrained. This feature becomes more significant in case of industrial automation where there may be battery powered sensing nodes installed to monitor the various characteristics. These small node or “motes,” are highly power-constrained. Motes cannot be relied upon to consistently transfer data to a distant node.
Highly distributed nodes. In scenarios such as traffic management system, there may be not only large number of nodes, but highly distributed nodes as well. In such scenarios not only the data matters, but the location of nodes matter as well.

### BRIEF SUMMARY OF THE INVENTION

In an aspect of the present invention, a method and apparatus for network conscious edge to cloud data aggregation, connectivity, analytics and actuation operate for the detection and actuation of events based on sensed data, with the assistance of edge computing software-defined fog engine with interconnect with other network elements via programmable internet exchange points to ensure end-to-end virtualization with cloud data centers and hence, resource reservations for guaranteed quality of service in event detection. An exemplary innovation is the use of programmable internet exchange points and SDN architecture at the network edge and cloud to ensure the end-to-end quality of service in the virtualized resource allocation and management framework for the Internet of Things and D2D applications.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

Claimed subject matter has particularly been pointed out and distinctly claimed in the concluding portion of the specification. However, the organization and/or method of operation, together with objects, features, and/or advantages thereof, may best be understood by reference to the following detailed description when read with the accompanying drawings in which:

FIG. 1 is a diagrammatic illustration of the integration of sensor nodes and devices in a fog networking architecture, in accordance with the present invention;

FIG. 2 is a diagrammatical illustration showing an end to end message passing structure from individual sensor devices via the programmable data plane, in accordance with the present invention;

FIG. 3 is a diagrammatical illustration representing the end to end fog architecture for guaranteed quality of service to sensor/IoT devices from a network edge via a programmable data plane;

FIG. 4 is a diagrammatical illustration representing the complete end-to-end architecture embedded in a wide area network;

FIG. 5 represents a top view of a sample target environment indicating the physical placement of static and mobile sensor along the various locations of sample target environment, in accordance with the present invention;

FIG. 6 represents a view and details of the apparatus and/or components present in the sensor nodes/nodes installed in the sample target environment of FIG. 5;

FIG. 7 represents a side view of the sample target environment of FIG. 5 under normal working conditions;

FIG. 8 represents the sample target environment of FIG. 5 in the case of occurrence of an explosion/event;

FIG. 9 shows the overall method for event detection, personnel and event localization;

FIG. 10 presents the details of the method for detecting the event in sample target environment;

FIG. 11 represents the sample target environment of FIG. 5 after the occurrence of an event; and

FIG. 12 shows the details of the method for prediction of location of an event and position of personnel after the event has occurred.

It will be appreciated that for simplicity and/or clarity of illustration, elements illustrated in the figure have not necessarily been drawn to scale. For example, the dimensions of some of the elements may be exaggerated relative to other elements for clarity. Further, if considered appropriate, reference numerals have been repeated among the figures to indicate corresponding or analogous elements.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The present invention relates generally to a method and apparatus for network conscious edge to cloud data aggregation, connectivity, analytics and actuation for a single or group of physical world devices or an application running on the device(s) or a virtual machine running on the device(s) linked to network controller(s) with underlying network infrastructure providing support for programmable data plane. The method provides devices capability for application specific end to end network resource reservation and virtualization for implementing custom solutions with support for features such as real time parameter sensing, reporting, anomaly/event detection, security, network, internet, fog, data center and/or cloud connectivity, social media integration, localization, activity monitoring, self healing, self configuration, and software-defined networking with a single or distributed set of network controllers coordinating the network functions.

A network of static or mobile sensing devices deployed in the sample target environment gathers information from the sources. The sensing device(s) or a subset of devices offload computation to edge computation machines with a request for services. A network controller provides device specific applications a subset of network links joining edge computation machines to devices and edge computation machines to the cloud data centres and/or programmable internet exchange points via programmable data forwarding plane to enable end to end application specific network virtualization. Applications running on edge device, in certain example embodiments, are used for monitoring the sample target environment, for example, for capturing a sequence of images, parametric sensing for applications such as water quality monitoring, presence and/or concentration of toxic gases, light intensity, intrusion detection, security, energy monitoring, structural integrity/stability, toxic materials, detecting and localizing collapses in case of accidents.

The system provides a method for sensing with guaranteed quality of support for a single or multiple tenants from both computing and network infrastructure. The system also provides the support for localization and actuation based on inference achieved from the aggregated data hence providing an enabling infrastructure for the Internet of everything. Two types of the models can be used while communicating data at scale: (i) a client server model; and (ii) a peer-to-peer model.

The disclosed fog architecture exhibits the following properties:

A fog network comprises fog nodes. These fog nodes may include resource constraint nodes, such as, for example, smart phones, personal Computers, or high resource devices, such as, for example, base-stations, core routers, road side units, or a dedicated server.

These fog nodes meet the criterion of proximity to the customer premises.

Fog nodes can cooperate with each other. A subset of the fog nodes working together can form a fog network using Peer-to-Peer (P2P) principles. All of these fog nodes are preferably connected to a cloud server to share information and for a central control.

The above three features are characterizing features of any fog network. A fog network cannot be designed without having all of these features. For a fog node to work impeccably within a fog network, the fog node has an architecture which can hide heterogeneity of devices, and can work seamlessly with user applications as well. The architecture illustrates that a fog node has a structure, including an abstraction layer and an orchestration layer.

The abstraction layer serves to hide the diversity and heterogeneity of devices, and provides a generic method of communication between the fog nodes and the devices by using Application Programming Interfaces (APIs). The abstraction layer exposes generic APIs for monitoring and controlling of physical resources such as energy, memory, processing power, as well as APIs, to specify security and isolation policies for different operating systems (Oss) running on the same physical machine.

The orchestration layer is responsible for management of tasks. The orchestration layer: (i) controls the functions of the fog network by allowing multi-tenancy using virtualization; and (ii) is responsible for starting and tearing down of services on a fog node, forming virtual machines to perform a service. Another important part of this architecture will be a centralized data base containing metadata about all the fog nodes, so that resources are allocated to an application based on the service requirements continually maintaining the quality of service (QoS).

Regarding the communication protocols among the different parts of a fog network, various possibilities exist. Discussing one such architecture as an example provides a fog architecture based on one M2M. Communication protocols between different hierarchies, such as device-fog nodes and northbound communication protocols to work with user demands, are required. Some of the points that are kept in mind while designing such protocols include ensuring that a protocol is generic so that different heterogeneous devices can use same standard protocols for communication with the fog node.

Some of the key features of the disclosed fog networking aspects include:
Client side control and configuration. For example for HetNets, each client has various radio access technologies available.
Client measurement and control signaling.
Data caching at the edge and resource pooling. Sharing of resources like bandwidth, computation and storage resources among the fog nodes.

This invention merges the information received from field deployed devices via Software Defined Networking (SDNs) with the message-oriented publish/subscribe Distributed Data Services (DDS) middleware to come up with a powerful and simple abstract layer that is independent of the specific networking protocols and technology for wireless sensor networks, internet of things, device to device and machine to machine working scenarios.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follows are presented in terms of methods or programs. These method descriptions and/or representations may include techniques used in the data processing arts to convey the arrangement of a computer system and/or other information handling system to operate according to such programs, algorithms, and/or symbolic representations of operations.

A method may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities.

Unless specifically stated otherwise, as apparent from the following discussions, it is appreciated that throughout the specification discussion utilizing terms such as processing, computing, calculating, determining, and/or the like, refer to the action and/or processes of a computer and/or computing system, and/or similar electronic and/or computing device into other data similarly represented as physical quantities within the memories, registers and/or other such information storage, transmission and/or display devices of the computing system and/or other information handling system.

Embodiments claimed may include apparatuses for performing the operations herein. An apparatus may be specially constructed for the desired purposes, or the apparatus may comprise a general purpose computing device selectively activated and/or reconfigured by a program stored in the device. Such program may be stored on a storage medium, such as, but not limited to, any type of disk, including floppy disks, optical disks. CD-ROMs, magnetic-optical disks, read-only memories (ROMs). random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device and/or other information handling system.

The processes and/or displays presented herein are not inherently related to any particular computing device and/or other apparatus. Various general purpose systems may be used with programs in accordance with the teachings herein, or it may prove convenient to construct a more specialized apparatus to perform the desired method. The desired structure for a variety of these systems will become apparent from the description below. In addition, embodiments are not described with reference to any particular programming language. It will be appreciated that a variety of programming languages may be used to implement the teachings described herein.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

It should be understood that certain embodiments may be used in a variety of applications. Although the claimed subject matter is not limited in this respect, the system disclosed herein may be used in many apparatuses such as in software development kit, training kits, performance logging systems, personal digital assistants, personal computers, laptops, handheld devices, cell phones, body mounted devices, local and wide area healthcare networks, and medical devices.

Types of wireless communication systems intended to be within the scope of the claimed subject matter may include, although are not limited to, Wireless Personal Area Network (WPAN), Wireless Local Area Network (WLAN), Wireless Ad Hoc Network, Wireless Wide Area Network (WWAN). Code Division Multiple Access (COMA) cellular radiotelephone communication systems. Global System for Mobile Communications (GSM) cellular radiotelephone systems, North American Digital Cellular (NADC) cellular radiotelephone systems, Time Division Multiple Access (TDMA) systems, Extended-TDMA (E-TDMA cellular radiotelephone systems, third and fourth generation {3G/4G} systems like Wideband CDMA(WCDMA), CDMA-2000, and/or the like, although the scope of the claimed subject matter is not limited in this respect.

Storage medium as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium, and the scope of the claimed subject matter is not limited in this respect.

Reference throughout this specification to one embodiment or an embodiment means that a particular feature, structure, or characteristic described in connection with the embodiment is included in at least one embodiment. Thus, the appearances of the phrase in one embodiment or an embodiment in various places throughout this specification are not necessarily all referring to the same embodiment. Furthermore, the particular features, structures, or characteristics may be combined in one or more embodiments.

A method to detect anomalies and events either onboard, with the assistance of an intermediary server at the network edge.

“It is an architecture that uses one or a collaborative multitude of end-user clients or near-user edge devices to carry out a substantial amount of storage, communication and control configuration, measurement management.” From this definition we can take fog network as network formed by resourceful edge devices, these devices can collaborate and cooperate with each other in a distributed manner.

Concept of fog is not meant to replace cloud rather to complement the cloud paradigm and to provide additional functionalities required by new generation networks. Fog computing provides a decentralized system in which we can share computing and storage resources at the edge, allowing real time data processing within the limitation of given bandwidth and power. Moreover fog network can provide the network control and management close to the users rather than controlled primarily by core network gateways.

In one embodiment, the controller platform, with its rich unique cross-section of SDN capabilities, Network Functions Virtualization (NFV), and IOT device and application management, can be bundled with a targeted set of features and deployed anywhere in the network to give the network/service provider ultimate control. Depending on the use case, the ODL IOT platform can be configured with only IOT data collection capabilities where it is deployed near the IOT devices and its footprint needs to be small, or it can be configured to run as a highly scaled up and out distributed cluster with IOT, SDN and NFV functions enabled and deployed in a high traffic data center.”

The embodiments disclosed herein represent a method and apparatus for network conscious edge to cloud sensing, communication, analytics, actuation, and virtualization. In an exemplary embodiment, the system and/or method and/or apparatus is used to ensure safety in a sample target environment via guaranteed end to end quality of service available using virtual data and control plane reservation via programmable network infrastructure. This involves the system and/or method to collect various types of data, wherein the data may be environmental parameters such as temperature, pressure, humidity, gaseous concentrations, water ingress, and/or data related to personnel such as location, activity, state, position in a sample target environment. In certain embodiments disclosed herein, the collected data may be used to detect and/or identify the anomaly and/or disaster event in the sample target environment via one or more anomaly and/or event detection methods. The anomaly and/or event detection method performs some operations and/or calculations and/or techniques that may detect the presence and/or occurrence of an anomaly and/or event. In one or more embodiments disclosed herein, an alarm is generated in case a disaster event is detected. In certain other embodiments the location of event and personnel affected by the event may be found and/or determined via suitable localization methods and/or algorithms after an alarm has occurred.

In an exemplary embodiment, the method provides support for SDNs, anomaly detection, self-healing, self-configuration, network QoS guarantees, virtual tenants, virtualization and localization. The SDN feature provides an IoT device the ability to connect to an SDN controlled data bank, thus ensuring two-way flow of data from the IoT physical world to cloud data centers.

In yet another embodiment, the method can embed any sort of sensor, camera, data acquisition device throughout a city. A controller such as OpenDaylight (ODL), is being used as an IoT data collection platform. The IoT data is organized in a massive resource tree, having potentially millions of nodes. The resource tree contains measurements from devices, referred to as the “things,: and associated attributes. The attributes represent metadata about the resource, for example, access rights, creation time, children list, owner, size, and quota. Where we have a cloud platform such as OpenStack, the OpenStack platform and the OpenDaylight controller can communicate with one another.

The AI reasoner detects any event. An application manager: changes the application in the IoT. Sensors can be chosen from same device or distributed set of devices. The virtualization engine acts to select desired set of IoT interfaces and connect them to the controller. It can select one device or multiple devices based on the application requirement with corresponding back-end resources and interfaces reserved as per the requirement from edge network all the way to the cloud data center.

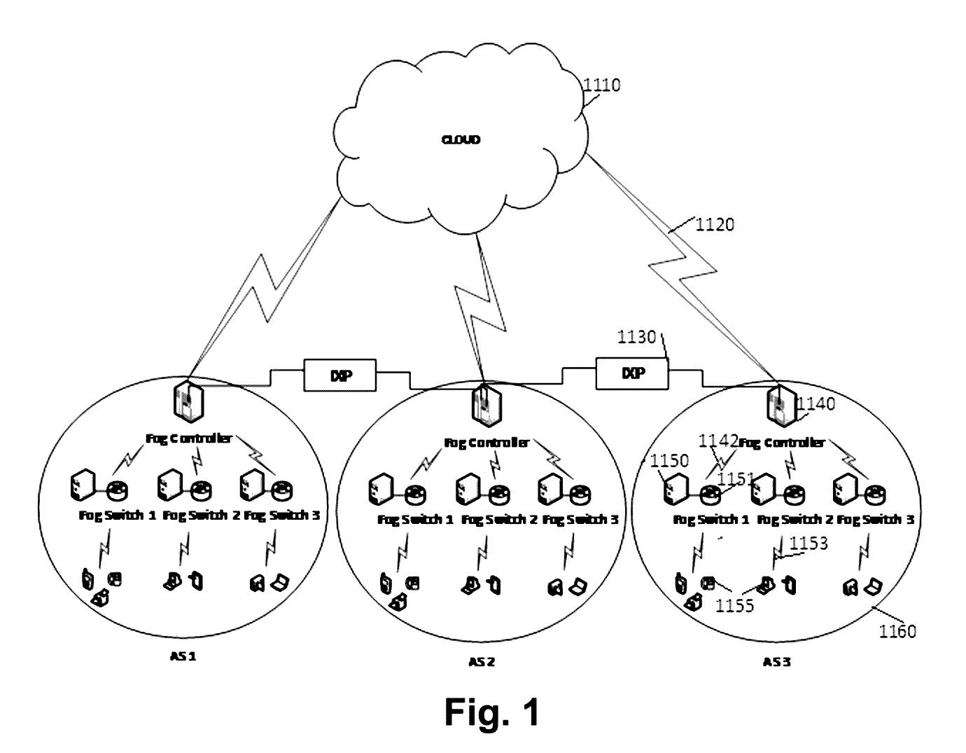

There is shown in FIG. 1 the integration of sensor nodes and devices in the disclosed fog networking architecture. The internet of things/wireless sensor devices 1155, as part of an autonomous system (AS) 1160, have a link with a fog switch 951 with an associated controller for functions such as but not limited to event detection, data orchestration, managing and programming the data plane from individual or functionally abstracted sensor nodes to the fog controller 1140 via a communication link 1142. Individual fog controllers coordinate among each other via a programmable internet exchange point 1130 ensuring low latency on major network intelligence and actuation tasks close to individual sensor nodes. Computationally or data intensive sensor node tasks are sent back all the way to a cloud data centre 1110 via a link 1120, results computed and sent back to individual client sensor nodes.

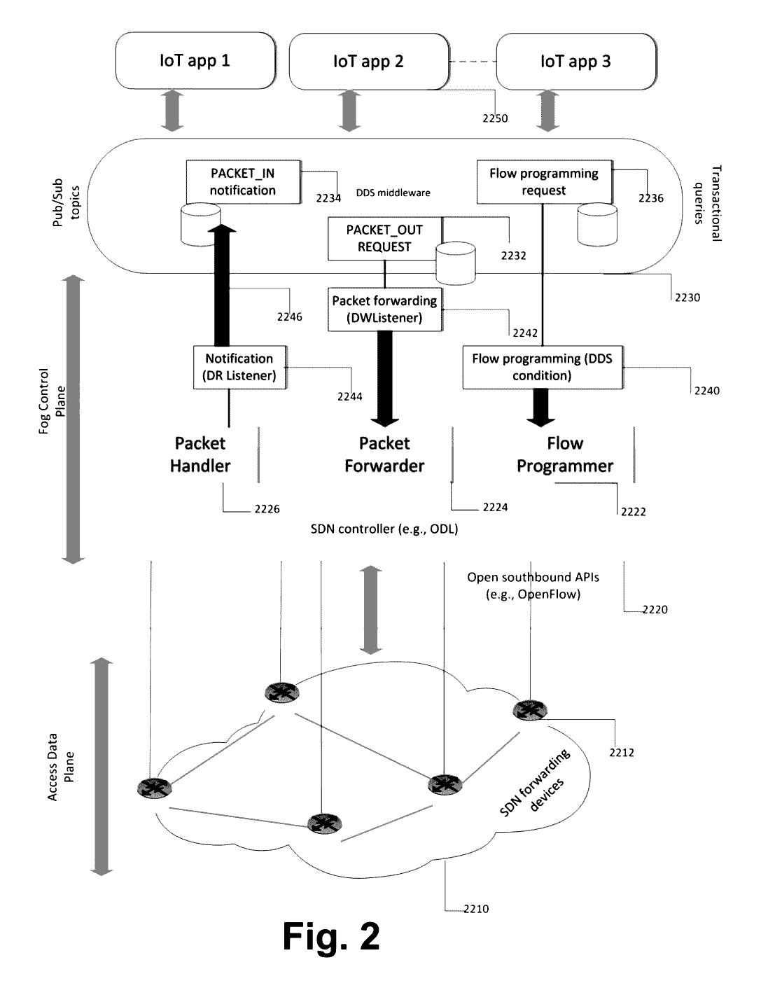

FIG. 2 provides an end to end message passing structure from individual sensor devices via the programmable data plane where the events are reported via the back-end architecture. 2210 is the collection of software defined networking enabled data forwarding plane where individual field deployed sensor devices communication to the higher abstraction layers through these programmable switches and routers 2212. 2220 represents the software defined network controller with 2222 Flow Programmer, 2224 Packet Forwarder and 2226 Packet Handler. 2230 represents the pub/sub service running all the way to the individual sensor devices in the field with 2232 packet out request manager, 2234 packet in notification handler, 2236 flow programming request, 2240 flow programming denial of service condition (DOS), 2242 packet forwarding listener and 2244 notification listener. 2250 represents the IoT applications such as event detection sitting on top of this architecture.

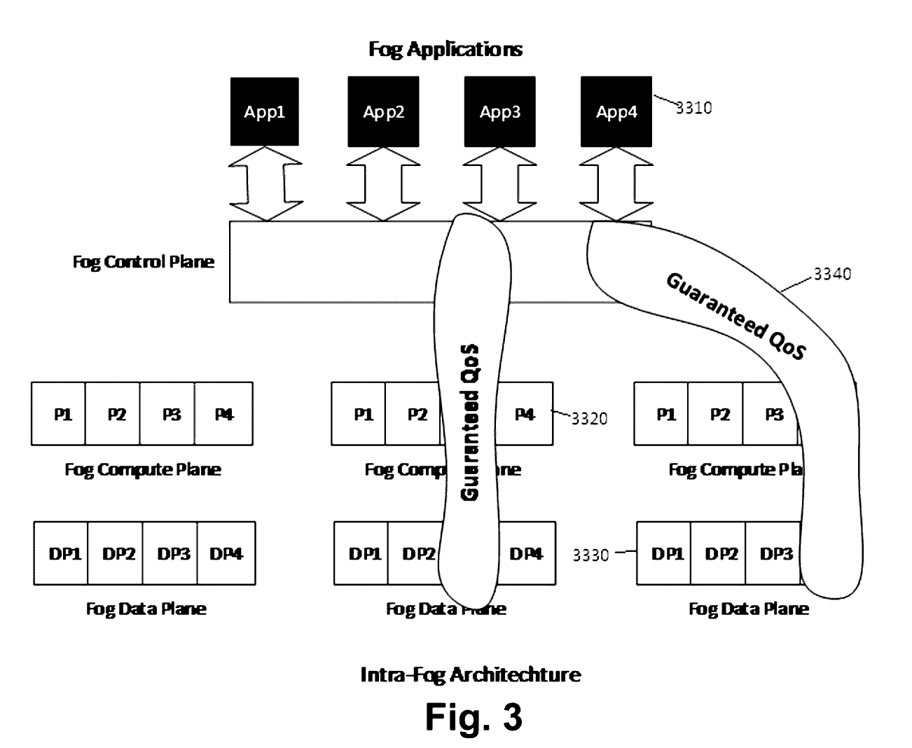

FIG. 3 represents the end to end fog architecture for guaranteed quality of service to sensor/iot devices from the network edge via programmable data plane and abstraction/orchestration of network resources right at the network edge. 3330 data plane, 3320 compute plane, 3340 control plane and 3310 represents the applications running on top of the network engine with guaranteed QoS provisioning via virtualized data path.

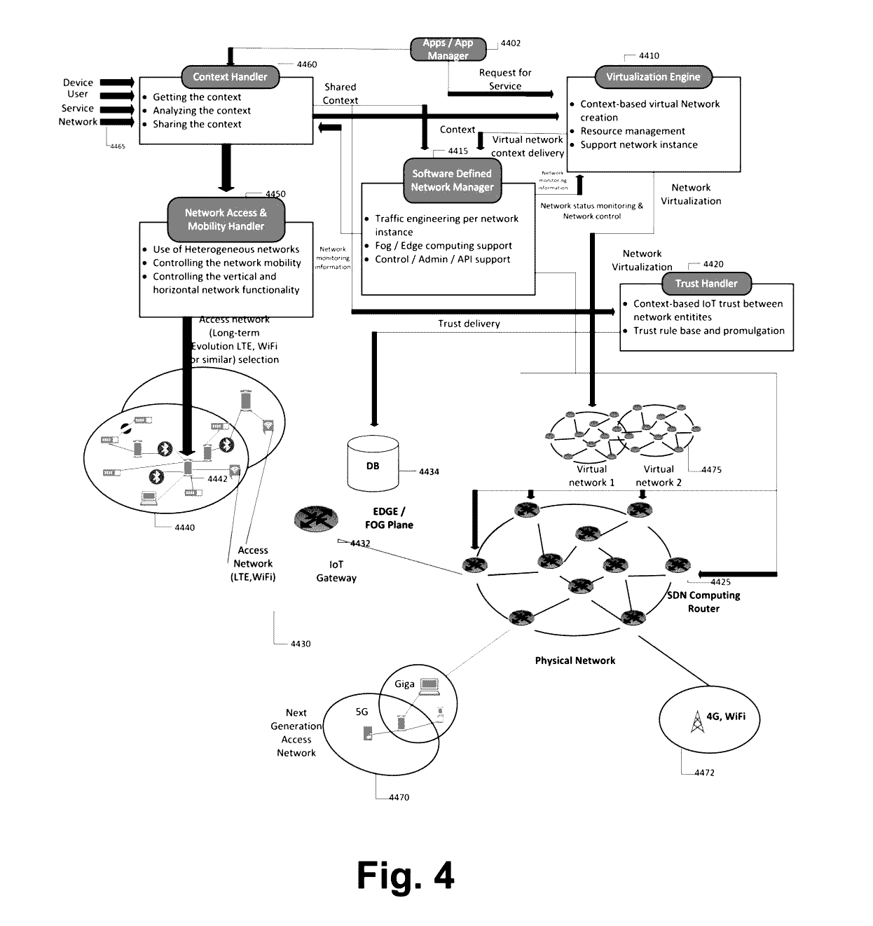

FIG. 4 represents the complete end to end architecture embedded in a wide area network with network managers, mobility and trust handlers and virtualization engines in order to ensure an end to end virtualization service is available with programmable network interfaces and SDN controllers. From top to bottom, 4402 represents an app manager, 4410 is a virtualization engine responsible for context based virtual network creation and resource management. 4415 represents a software defined network manager responsible for engineering the network traffic and provision of edge computing support. 4420 represents context based IoT trust between network entities. 4425 represents a pool of SDN computing routers, 4G/Wifi device networks. 4430 represents the fog computing engine at the network edge with an associated IoT gateway 4432, a database 4434 and corresponding links with IoT devices such as 4440 with one computing sensor device as 4442. 4450 ensures network access is provided to the right set of entities even in a heterogeneous network setting whereas 4460 maintains context and shares it with the neighbouring network elements. 4470 and 4472 represents the 4G and 5G network elements integration with the proposed architecture.

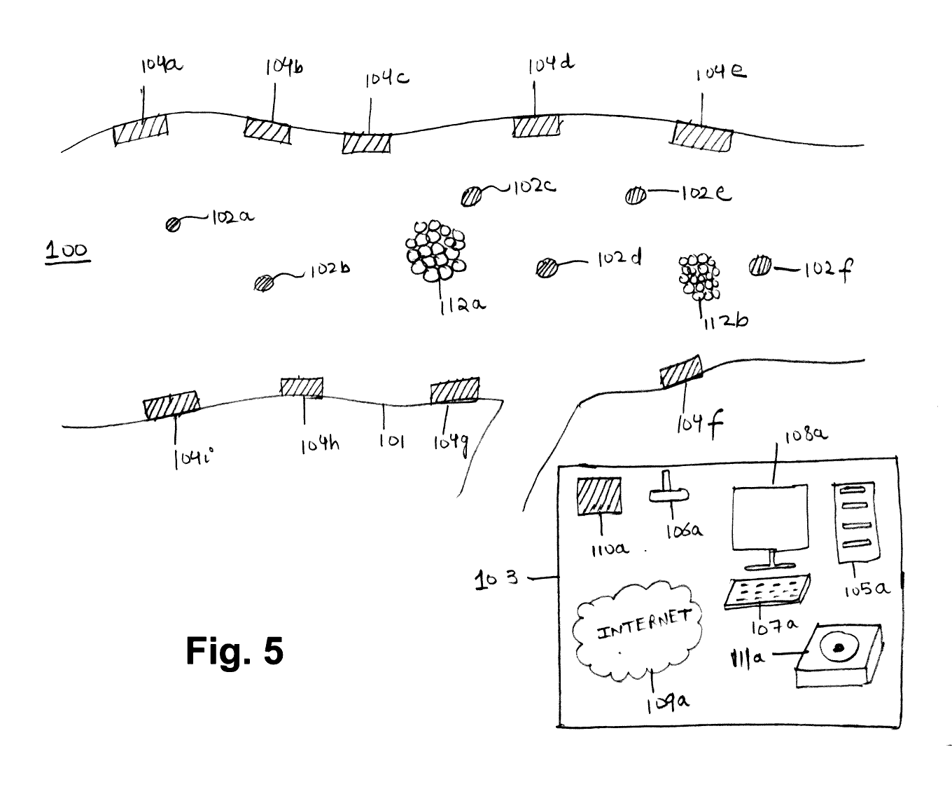

FIG. 5 is a diagrammatical illustration of a safety assurance system 100 deployed in a sample target environment 101. The target environment includes key stress points 112a and 112b. Various types of data may be collected from mobile sensors 102 a through 102f, and static sensors 104a through 104i, installed and/or deployed at various places throughout the sample target environment 101. The static sensors 104a through 104i may be deployed at fixed locations and/or key stress and/or specific positions along the sample target environment 101. The mobile sensors 102a through 102f may be attached and/or coupled to the waist and/or other body part(s) of the personnel working inside the sample target environment 101 and hence, may change their position or location with the movement of personnel.

Any one or more of the static sensors 104a through 104i and the mobile sensors 102a through 102f can be either in sleep mode or in active mode. A sensor in the sleep mode has limited communication and computation capabilities. While a sensor in the sleep mode may be able to process data collected by performing calculations and/or processing algorithms, the sensor in the sleep mode may not be able to transmit and/or broadcast large volumes of data to the neighboring and/or central nodes. A sensor in an active mode has more communication and computation capabilities than in the sleep mode. The sensor in an active mode can process data as well as broadcast and/or transmit huge volumes of data to certain neighboring and/or central nodes.

One or more of the sensors, 102a through 102f and 104a through 104i, may transmit and/or broadcast data to a central server and/or central node 103. The central node 103 has higher communication and computation capabilities than any sensor node, 102a through 102f and 104a through 104i, and is not resource-constrained. The central node 103 comprises a processor apparatus 105a, a wireless transceiver 106a, an issuing apparatus 107a, a display apparatus 108a, and a storage medium 111a. The central node 103 processes the greater volumes of data via the processor apparatus 105a, and transmits and receives various types of data from one or more of the nodes 102a through 102f and 104a through 104i via the wireless transceiver 106a. The central node 103 may further issue commands to other nodes via the issuing apparatus 107a, and may visualize collected data on the display apparatus 108a. In case of a disaster event or other unfavorable conditions, the central node 103 processes appropriate alarms. The central node 103 may also communicate with an external network 109a by using a wired or a wireless connection. Moreover, the central node 103 may also include one or more local sensors 110a to collect data from the locality proximate the central node 103, and save all the collected data in the storage medium 111a.

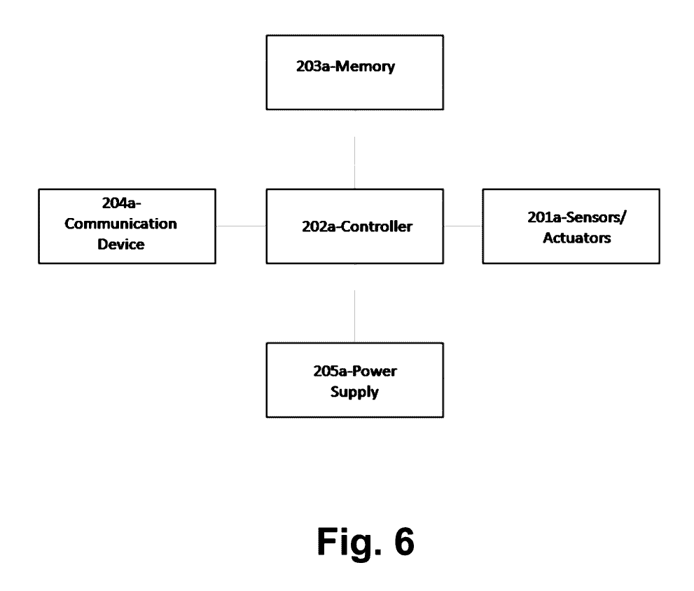

FIG. 6 is a system diagram showing the structure of the sensors, 102a through 102f and 104a through 104i shown in FIG. 51. Each of the mobile sensors 102a through 102f, and the static sensors 104a through 104i, comprises a sensor/actuator 201a in communication with a sensor controller 202a, as shown in FIG. 6. The sensor/actuator 201a may measure one or more of temperature, pressure, humidity, light concentrations, toxic gases concentration, water ingress, vibration, or movement, and may store the collected data in a sensor memory 203a. The data in the sensor memory 203a may be processed by means of a sensor controller 202a to produce sensor statistics. The sensor statistics may be wirelessly transmitted and/or broadcasted via a communication device 204a. The data and/or statistics from other sensor nodes may be received via the communication device 204a. The sensor/actuator 201a, sensor controller 202a, the sensor memory 203a, and the communication device 204a are powered by a power supply 205a. The central sensor 103 shown in FIG. 5 may also comprise the sensor/actuator 201a, sensor controller 202a, the sensor memory 203a, and the communication device 204a for collecting and/or processing and/or examining central sensor data.

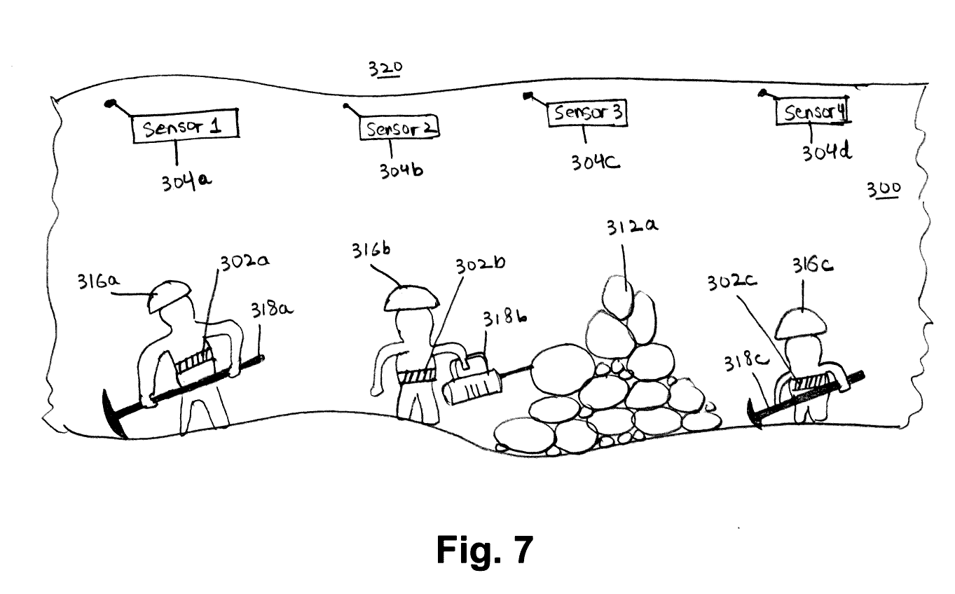

FIG. 7 is a diagrammatical view of a safety assurance system 300 as deployed in a target environment 320. The safety assurance system 300 comprises One of the embodiments disclosed herein represents some static sensors 304a through 304d. In yet another embodiment disclosed herein mobile sensors 302a through 302c attached to the waists of the personnel 316a through 316c. The personnel 316a through 316c working and/or visiting the sample target environment may or may not possess some measurement and/or excavation and/or drilling tools or apparatus 318a through 318c. Further the sample target environment may or may not consist of one or more key stress points/areas 312a, similar to 112a through 112b disclosed in 100 of FIG. 1, which may pose threat to the personnel 318a through 318c working inside the environment.

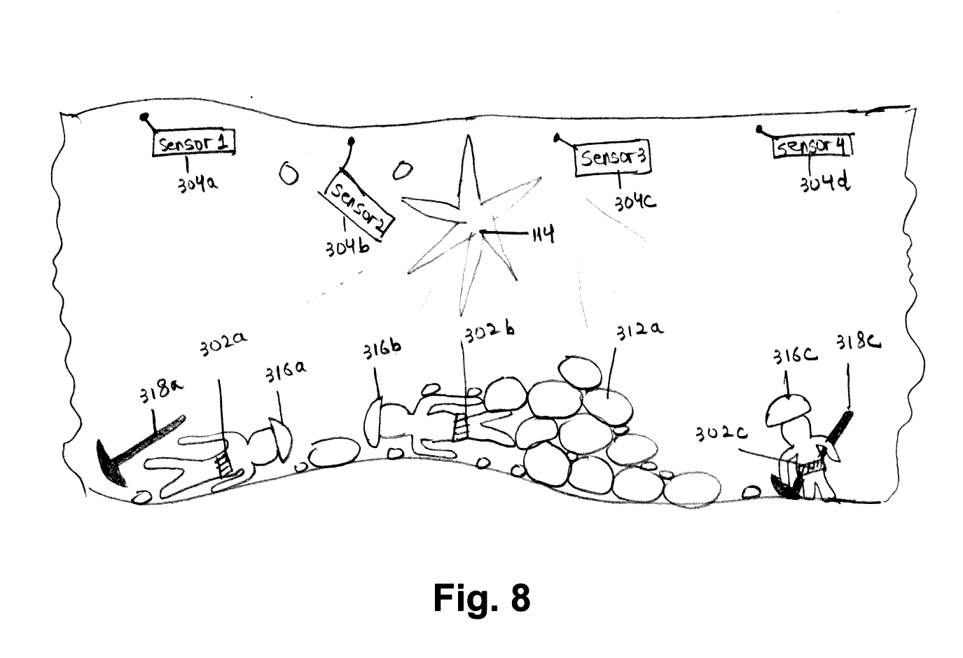

FIG. 8 is a diagrammatical illustration of the target environment 320 in which an event 114 has occurred. The event may be, for example, a collapse or an explosion. The event 114 may cause one or more of the sensor nodes 304a through 304d to respond, in accordance with the embodiments disclosed in 100 of FIG. 5 and FIG. 7, in the range of the event 114 to collapse and/or break and/or fall. In a similar manner one or more of the personnel 318a through 318c possessing one or more mobile nodes 302a through 302c may also be affected by the event 114.

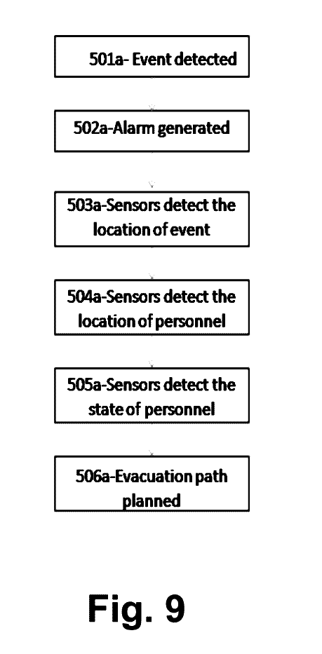

FIG. 9 is a flow diagram 500 illustrating operation of the safety assurance system 300 of FIG. 3 for ensuring safety in the target environment 320. The event 114 may be detected and/or identified in STEP 501a by performing operations and/or processes on the environmental data collected from sensors 304a through 304d, directly or after storing the data in a storage medium, such as the sensor memory 203a, shown in FIG. 6. In response to the detection of the event 114, an alarm may be generated by the central sensor 103 or, alternatively, a server (not shown) and/or a gateway (not shown), at step 502a.

After the detection of the event 114 in step 501a, and the generation of an alarm, in step 502a, the central node 103 and/or server and/or gateway may request the location of the event 114, at step 503a. One or more of the sensors 304a through 304d, which detected the event 114 in accordance with the embodiments disclosed in FIG. 5 and FIG. 7, may provide the location of the event 114 via the issuing apparatus 107a and the wireless transceiver 106a, as shown in FIG. 1.

At step 504a of FIG. 9, after the detection of the event 114 in step 501a, the generation of the alarm in step 502a, the request of the location of the event 114, in step 503a, the central node 103 or server or gateway may request one or more of the sensor nodes 304a through 304d, which detect the event 114, for the location of one or more of the personnel 318a through 318c via the issuing apparatus 107a and the wireless transceiver 106a. Optionally, at step 505a of FIG. 9, the central node 103 may request one or more of the nodes 302a through 302c to determine the state and/or position and/or movement of one or more of the personnel 318a through 318c. In response to the steps 501a to 505a, the central node 103 may further plan a safe evacuation path for personnel 318a through 318b, at step 506a, based on the information and/or data and/or locations collected in steps 501a through 505a.

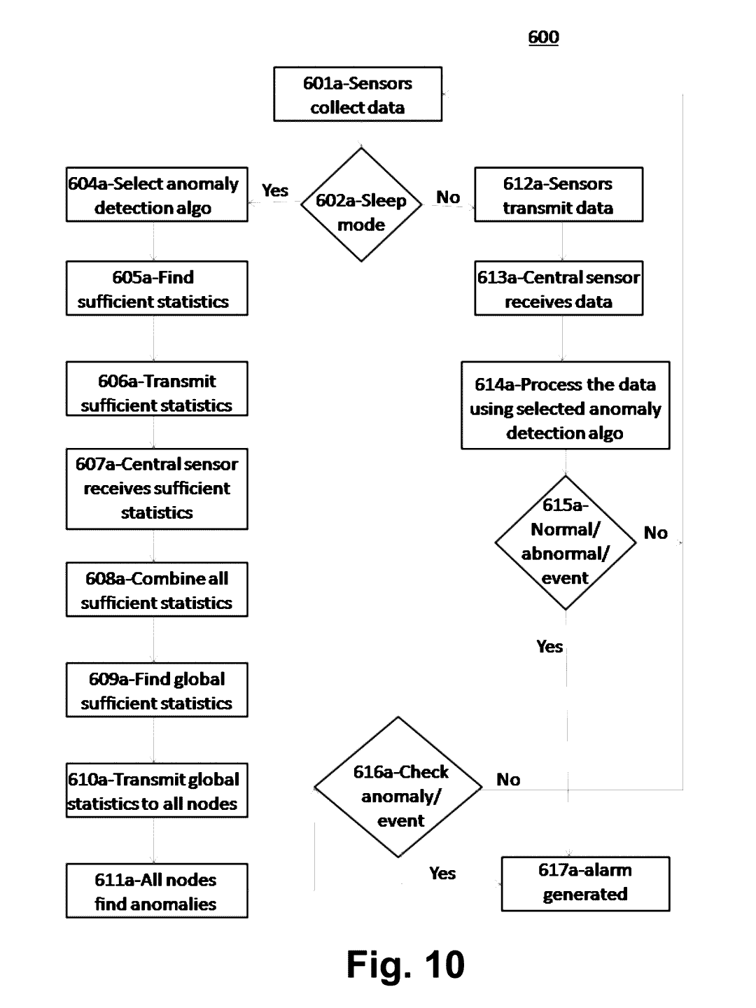

FIG. 10 shows a flow diagram 600 illustrating a method and procedure for detecting and identifying an undesirable anomaly, such as a collapse or an explosion. In step 601a, one or more of the sensors 102a through 102c and 304a through 304d may collect the environmental data comprising one or more of the temperature, pressure, humidity, gaseous concentrations, water ingress and light concentrations of the proximate environment via the sensor/actuator 201a shown in FIG. 6. The collected data may be stored in a storage apparatus such as the sensor memory 203a.

At decision block 602a the method checks to determine if a particular sensor 102a through 102c or 304a through 304d, for example, is in a sleep mode. If at decision block 602a, it is determined that the sensor is not in the sleep mode, and has an excess of battery power, the method proceeds to step 612a of FIG. 10. However, if the sensor is in the sleep mode, then the method proceeds to step 604a, wherein the sensor has more computational but very less communication capability, or the sensor has limited power supply and/or battery power, as may be determined by the characteristics of the power supply 205a in FIG. 6.

At step 604a, the sensor selects an anomaly detection algorithm. The anomaly detection algorithm may process the collected environmental data using a computational device such as the processor apparatus 105a, in FIG. 5, and/or the sensor controller 202a, in FIG. 6. The anomaly detection algorithm selected in step 604a may belong to one or more of statistical, clustering, artificial intelligence and/or machine learning based fields. The anomaly detection algorithm may operate upon the collected data on some trigger conditions after some time intervals and may determine some sufficient statistics representative of the collected data, in step 605a. The sufficient statistics may include parameters such as, for example, the radius of the cluster and/or median and/or mean of the data and/or linear sum of squares and/or variance and/or standard deviation. Since the sensor nodes operating and/or processing the anomaly and/or event detection algorithm selected in step 604a are in sleep mode, therefore it is beneficial to operate the method and/or algorithm less often and determine a few parameters representative of the data, as in step 605a.

At step 606a, the sufficient statistics determined and/or evaluated in step 605a may be transmitted and/or broadcasted and/or communicated to one or more of the neighboring and/or central nodes of the sensors 102a through 102c and/or 304a through 304d, and/or the central node 103, via the wireless transceiver 106a. Upon receiving the sufficient statistics in step 607a, one or more of the neighboring nodes of the sensors 102a through 102c and/or 304a through 304d, and the central node 103, will combine all the sufficient statistics received, at step 608a, via one of the sensor controllers 202a and/or the processor apparatus 105a to obtain a global decision, at step 609a.

At step 610a, the determined and/or calculated sufficient statistics may be broadcasted and/or transmitted from the central node 103 to all the nodes 102a through 102c and/or 304a through 304d, in the sample target environment, via the wireless transceiver 106a in FIG. 5. In the step 611a, the nodes 102a through 102c and 304a through 304d may compare their respective collected data with the obtained sufficient statistics from the central node 103, and classify the data as normal and/or abnormal. The data labeled as abnormal, in step 611a, may further be determined to be outlier or an event, at decision block 616a, by comparing with the decisions of one or more of the neighboring nodes 102a through 102c and/or 304a through 304d. If the data is classified as an event, in decision block 616a, the central node 103 may generate an alarm in step 617a, on receiving the event information from one or more of the sensor nodes involved in the event 114 in response to a detected event 114, such as depicted in FIG. 8. However, if the abnormal data does not indicate the detection of an event 114, at decision block 616a, the sensors 102a through 102c and 304a through 304d will continue collecting data, at step 601a.

At step 612a, if one or more of the sensor nodes 102a through 102c or 304a through 304d are not in the sleep mode, then the sensor nodes 102a through 102c or 304a through 304d may transmit and/or broadcast and/or communicate the stored collected data to the central node 103. At step 613a the central node 103 may receive the collected data via the wireless transceiver 106a. After having received the data of one or more nodes in step 613a, the central node 103 may select the anomaly detection algorithm, in step 614a, to process the collected data. The anomaly detection algorithm selected in step 614a may belong to one of the fields of statistics or clustering or artificial intelligence or machine learning. The central node 103, after collecting the data in step 613a, and after selecting the anomaly detection algorithm in step 614a, may process the collected data via the selected anomaly detection algorithm in step 614a, using the processor apparatus 105a, or the sensor controller 202a. At decision block 615a, and after processing the data in step 614a, the central node 103 may determine whether the data collected at step 613a is normal or abnormal, or is representative of an event. If the collected data does not point to an event in decision block 615a, the central node 103 return to step 601a and will direct the sensors 102a through 102c and 304a through 304d to continue collecting data.

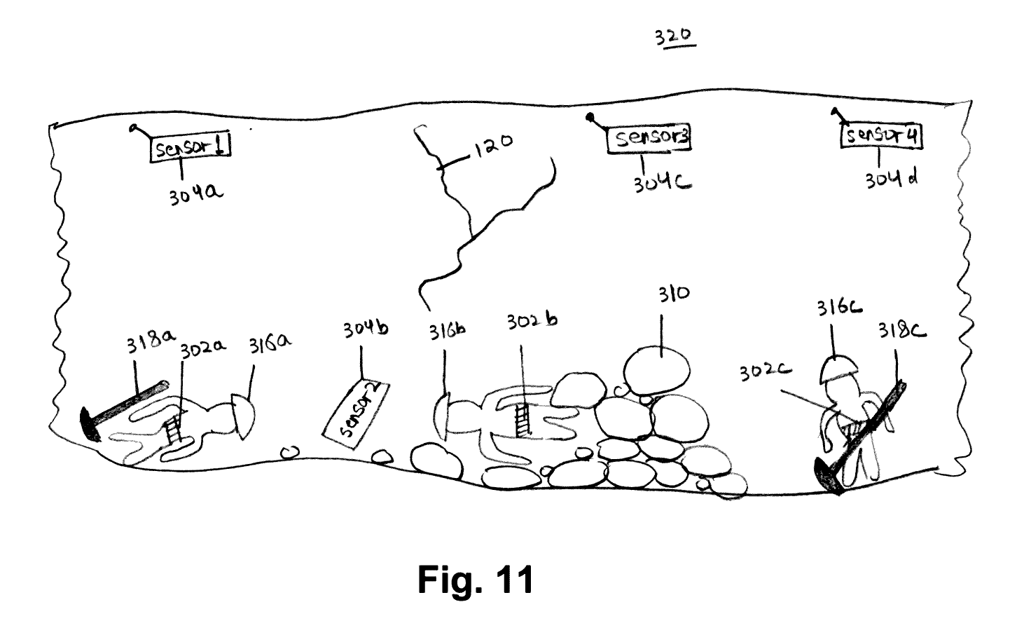

FIG. 11 shows the target environment 320 after the occurrence of the event 114. The sensor node 304b has fallen, a rockslide 310 is present, and some disaster 120 has occurred in the target environment 320. In the example shown, one or more of the personnel 316a through 316c working and/or visiting the sample target environment may also be affected by the event 114. After the occurrence of the event 114, the location of the event 114 is determined via one or more nodes 102a through 102c and 304a through 304c. The location of personnel affected by the event is also determined via a specified localization method and/or algorithm, with reference to one or more of the sensor nodes 304a through 304d near the event location.

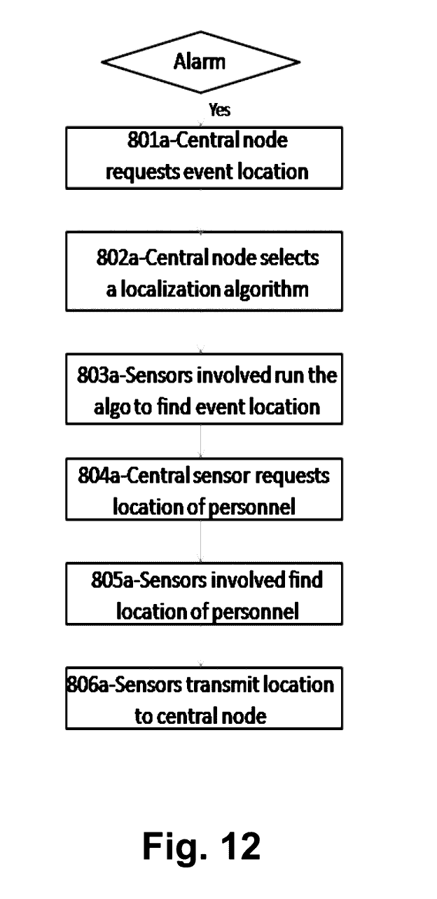

FIG. 12 shows a flow diagram 800 illustrating a sequence of methods and/or processes that may be followed and/or performed after the occurrence of the event 114. After the detection of an event in decision block 616a and step 615a, above, and the generation of the alarm in step 617a, the central node 103 may request the location of the event 114, at step 801a, from one or more of the sensor nodes 304a through 304d or 102a through 102c, at step 801a. The sensor may also select some localization algorithm and/or method in step 802a, and may also transmit and/or broadcast and/or communicate the choice of algorithm and/or method to one or more of the sensors, along with the request for location.

At step 803a, one or more of the sensor nodes runs the localization algorithm selected in step 802a to detect the location of the event 114. After the determination of event location in step 803a, the information is then transmitted and/or communicated back to the central node 103 in step 804a. The central node 103 then requests the location of one or more personnel 316a through 316c that have been affected by the event from one or more of the sensor nodes 102a through 102c and/or 304a through 304d, at step 804a. At step 805a, one or more of the sensors which detect the event 114 may communicate with one or more of the personnel 316a through 316c, via one or more of the sensors 302a through 302c present around the waist and/or body of the respective personnel. The location(s) of one or more personnel, affected in the event 114 and determined at step 805a, is transmitted and/or communicated back to the central node 103 in step 806a. The central node 103 then may or may not plan a safe evacuation path for the personnel trapped inside the sample target environment 302.

Although the claimed subject matter has been described with a certain degree of particularity, it should be recognized that elements thereof may be altered by persons skilled in the art without departing from the spirit and/or scope of the claimed subject matter. It is believed that the method of ensuring safety in a sample target environment and detection of anomaly and/or event via the data collected from various sensor nodes will be understood by the foregoing description, and it will be apparent that various changes may be made in the form, construction and/or arrangement of the components and/or method thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A computer apparatus for network conscious edge to cloud sensing, communication, analytics, actuation and virtualization, said apparatus comprising:
a plurality of devices connected to a network controller via a reliable communication link, each said device capable of sensing, communication, analytics and actuation in its vicinity;
wherein a data plane from the plurality of devices to a network edge/fog engine to the cloud and to internet exchange points are a programmable data plane with an ability to reserve resources as per application requirements;
wherein there is provisioning for monitoring and managing services in a network, said network including
a fog controller at said network edge to coordinate functions of said programmable data plane and network edge connected devices;
wherein said collection of fog controllers communicating with each other and cloud via software defined programmable internet exchange points; and
a programmable data plane for access provisioning to end user devices to said network edge connected central fog server to a back end cloud and intermediate software defined programmable internet exchange points;
said fog nodes interconnected with each other either directly or via the programmable exchange points with said programmable network interfaces and said data plane.

2. A method for provisioning, monitoring and managing services in a network comprising the steps of extracting and analyzing device, user, service, and network contexts to create and utilize virtual networks, selecting heterogeneous access networks, and implementing trust in IoT services.

3. The method of claim 2 further comprising the step of interconnecting a plurality of IoT services and end devices with different network technologies.

4. The method of claim 2 further comprising the step of offering a virtual network instance as a service by virtualizing a physical network, bandwidth reservation, differentiated QoS support, flow control, and load balancing individually for different IoT services.

5. The method of claim 2 wherein evolvable network architecture employing network virtualization and traffic engineering through network functions virtualization/software defined networking, integrates edge/fog computing with programmable internet exchange points for virtual control of physical world sensor devices.

6. The method of claim 2 further comprising the step of utilizing a context handler to extract context from at least one of a device, a user, a service, and a network.

7. The method of claim 2 wherein a virtualization manager functions to receive context from a context handler, and to receive network monitoring information from a software-defined network manager.

8. The method of claim 2 further comprising the step of sending network monitoring information to a context handler via n software defined network manager.

9. The method of claim 2 further comprising the step of receiving, via a virtualization manager, an instance of virtualized network created by said virtualization manager.

10. The method of claim 2 further comprising the step of receiving context from a context handler via a network access and mobility handler.

11. The method of claim 2 further comprising the steps of:
receiving context from a context manager;
evaluating, via a trust rule engine, said received context based on a user's past records; and
determining whether additional authentication is necessary.

12. An article of manufacture including a non-transitory computer-readable storage medium having instructions stored thereon that are executable by a machine to cause the system to perform operations including the steps of: extracting and analyzing device, user, service, and network contexts to create and utilize virtual networks, selecting heterogeneous access networks, and implementing trust in IoT services.
